(19) United States
(12) Patent Application Publication
(10) Pub. No.: US 2006/0152158 A1
(43) Pub. Date: Jul. 13, 2006

(54) Protecting layer for use in plasma display panel (PDP), method of forming the protecting layer, and PDP including the protecting layer

(76) Inventors: Min-Suk Lee, Suwon-si (KR); Yuri Matulevich, Suwon-si (KR); Jong-Seo Choi, Suwon-si (KR); Suk-Ki Kim, Suwon-si (KR); Jae-Hyuk Kim, Suwon-si (KR); Soon-Sung Suh, Suwon-si (KR)

Correspondence Address: ROBERT E. BUSHNELL, 1522 K STREET NW, SUITE 300, WASHINGTON, DC, 20005-1202, US

(21) Appl. No.: 11/298,951

(22) Filed: Dec. 12, 2005

(30) Foreign Application Priority Data
Dec. 13, 2004 (KR) 10-2004-0104942

(51) Int. Cl. H01J 17/49; H01J 9/24

(52) U.S. Cl. 313/586; 313/587; 445/14; 445/24

(57) ABSTRACT

A protecting layer of a Plasma Display Panel (PDP) is composed of metal and metal oxide. The metal is disposed away from the surface of the protecting layer by 10% or less than the thickness of the protecting layer. Furthermore, in a method of forming the protecting layer for a PDP and in a PDP employing the protecting layer, the metal is disposed away from the surface of the protecting layer by 10% or less than the thickness of the protecting layer.

### CLAIM OF PRIORITY

This application makes reference to, incorporates the same herein, and claims all benefits accruing under 35 U.S.C. §119 from an application for A PROTECTING LAYER FOR USE IN PLASMA DISPLAY PANEL, A METHOD OF FORMING THE SAME, AND A PLASMA DISPLAY PANEL COMPRISING THE SAME earlier filled in the Korean Intellectual Property Office on 13 Dec. 2004 and there duly assigned Serial No. 10-2004-0104942.

### BACKGROUND OF THE INVENTION

1. Field of the Invention

The present invention relates to a protecting layer for use in a Plasma Display Panel (PDP), a method of forming the protecting layer, and a PDP including the protecting layer, and more particularly, to a protecting layer formed by employing a metal arranged away from the surface of the protecting layer by 10% or less ofthe thickness of the protecting layer, and having improved secondary electron emission characteristics and discharge characteristics with respect to plasma ions formed by an Ne+Xe mixture gas or an He+Ne+Xe mixture gas, a method of forming the protecting layer, and a PDP including the protecting layer.

2. Description of the Related Art

A Plasma Display Panel (PDP) has characteristics of easily realizing a large screen, an excellent display image quality by spontaneous emission, and a high response speed. Furthermore, since a PDP can be made of a thin and flat, it can constitute a wall hanger display along with a Liquid Crystal Display (LCD) or the like.

A PDP includes a sustain electrode disposed on the lower surface of a front substrate, the sustain electrode having a first electrode and a second electrode. The sustain electrodes are coated with a dielectric layer. When the dielectric layer is directly exposed to a discharge environment, discharge characteristics can deteriorate and its lifetime shortened. Accordingly, the dielectric layer is covered with a protecting layer.

An address electrode having a predetermined pattern is disposed on a rear substrate, and a dielectric layer is formed to cover the address electrode and the rear substrate. The front substrate and the rear substrate are disposed opposite to each other. A space between the two substrates is filled with a mixture gas including Ne+Xe or a mixture gas including He+Ne+Xe for generating ultraviolet rays at a predetermined pressure (for example, 450 torr). The Xe gas functions to generate vacuum ultraviolet rays (Xe ion: 147 nm resonance radiation, Xe_{2: 173} nm resonance radiation).

Using Xe gas only, as high density vacuum ultraviolet rays is possible, visible rays conversion can be possible up to quantum efficiency of fluorescent material, but since a discharge F initiation voltage is very high, it is actually difficult to employ to a display device. In recent trends, Xe content has been increased for a high brightness, and studies have been actively made in order to lower a discharge initiation voltage increased along with increase of the Xe content. Among the studies, one method includes adding He gas to Ne+Xe mixture gas, and the method is advantageous to lower a discharge initiation voltage as He ion has a high momentum. Addition of He gas is apparently advantageous for discharge of high Xe content, but sputtering and etching problems may occur in the protecting layer more seriously. Hence, it is not apparent whether or not to employ the method.

A function of the protecting layer for use in the PDP can be roughly divided into three points.

First, the protecting layer functions to protect an electrode and a dielectric layer. When an electrode or a dielectric layer/electrode exists, discharge occurs. However, if only an electrode exists, it is difficult to control a discharge current, while if only a dielectric layer/electrode exists, the dielectric layer may be damaged by sputtering and etching. Therefore, the dielectric layer must be coated with the protecting layer resistive to plasma ions.

Secondly, the protecting layer functions to lower a discharge initiation voltage. A physical quantity directly related with a discharge initiation voltage is a secondary electron emission coefficient of a material to form the protecting layer with respect to plasma ion. As the amount of the secondary electrons emitted from the protecting layer is increased, the discharge initiation voltage is decreased. Thus, the protecting layer is preferably composed of a material having a high secondary electron emission coefficient.

Lastly, the protecting layer functions to shorten a discharge delay time. The discharge delay time is a physical quantity to explain a phenomenon that discharge occurs in a predetermined time with respect to an applied voltage, and it can be presented as sum of formation delay time (Tf) and statistical delay time (Ts). The formation delay time is time difference between applied voltage and discharge current, and the statistical delay time is statistical distribution of the formation delay time. As the discharge delay time is shortened, high speed addressing and single scanning are possible. Also, scan drive cost is reduced, and the number of sub-field is increased, thereby providing a PDP of high brightness and high display image quality.

In consideration of these points, studies are actively made to lower a discharge initiation voltage of a PDP and shorten a discharge delay time by controlling the protecting layer of the PDP. For example, Japanese Patent Publication No. 2002-110050 relates to an AC PDP having a magnesium oxide protecting layer covering a dielectric layer disposed on a front substrate.

However, the PDP protecting layer could not provide a satisfactory discharge initiation voltage and a reduction effect of a discharge delay time. Therefore, further improvement is urgently required to achieve a PDP with a long life time and a high display image quality.

### SUMMARY OF THE INVENTION

The present invention provides a metal protecting layer for use in a Plasma Display Panel (PDP), a method of forming the protecting layer, and a PDP employing the protecting layer.

According to one aspect of the present invention, a protecting layer is provided for use in a PDP, the protecting layer including metal and metal oxide. The metal is disposed away from the surface of the protecting layer by 10% or less than the thickness ofthe protecting layer.

The metal preferably includes one or more metals selected from the group consisting of Mg, Al, Sc, Ti, Cr, Ni, Cu, and Mo.

The metal oxide is preferably magnesium oxide.

The metal preferably has a predetermined pattern.

The metal having a predetermined pattern is preferably buried into a layer composed of the metal oxide.

The metal preferably has a particle shape, and is preferably dispersed into a layer composed of the metal oxide.

The metal preferably has a particle shape, and is preferably surface-coated with the metal oxide.

The metal having a particle shape preferably has a diameter in a range of 50 nm to 1000 nm.

According to another aspect of the present invention, a method of forming a protecting layer for use in a PDP is provided, the method including: preparing a substrate; forming a predetermined pattern composed of metal on the substrate; and forming a layer composed of magnesium oxide to cover the metal having the predetermined pattern. A layer composed of magnesium oxide is formed such that the metal having the predetermined pattern is disposed away from a surface of the protecting layer by 10% or less than the thickness of the protecting layer.

Before forming a predetermined pattern composed of metal, the method preferably further includes forming a layer composed of magnesium oxide on the substrate.

According to still another aspect of the present invention, a method of forming a protecting layer for use in a PDP is provided, the method including: preparing an evaporation source supplying metal and magnesium oxide, and a substrate; and forming a layer composed of the metal and magnesium oxide on the substrate, using the evaporation source.

According to another further aspect of the present invention, a PDP employing the protecting layer for use in a PDP as described above is provided, or employing the protecting layer for use in a PDP formed by the method as described above is also provided.

Therefore, since the protecting layer for use in a PDP according to the present invention as described above has excellent protecting characteristics of dielectrics, discharge characteristics, and secondary electrons emission characteristics, the PDP employing the protecting layer has a long life time and a high quality display image.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of an example of a pixel of a Plasma Display Panel (PDP);

FIG. 2 is a schematic view of an Auger neutralization theory to explain an electron emission from a solid by a gas ion;

FIG. 3 is a schematic view of an Auger neutralization theory explaining an electron emission from a metal oxide by a gas ion, and concurrently, a mechanism accelerating the electron emission by a metal;

FIGS. 4 through 7 are sectional views of an example of a protecting layer according to the present invention; and

FIG. 8 is a view of an example of a PDP employing an example of the protecting layer according to the present invention.

### DETAILED DESCRIPTION OF THE INVENTION

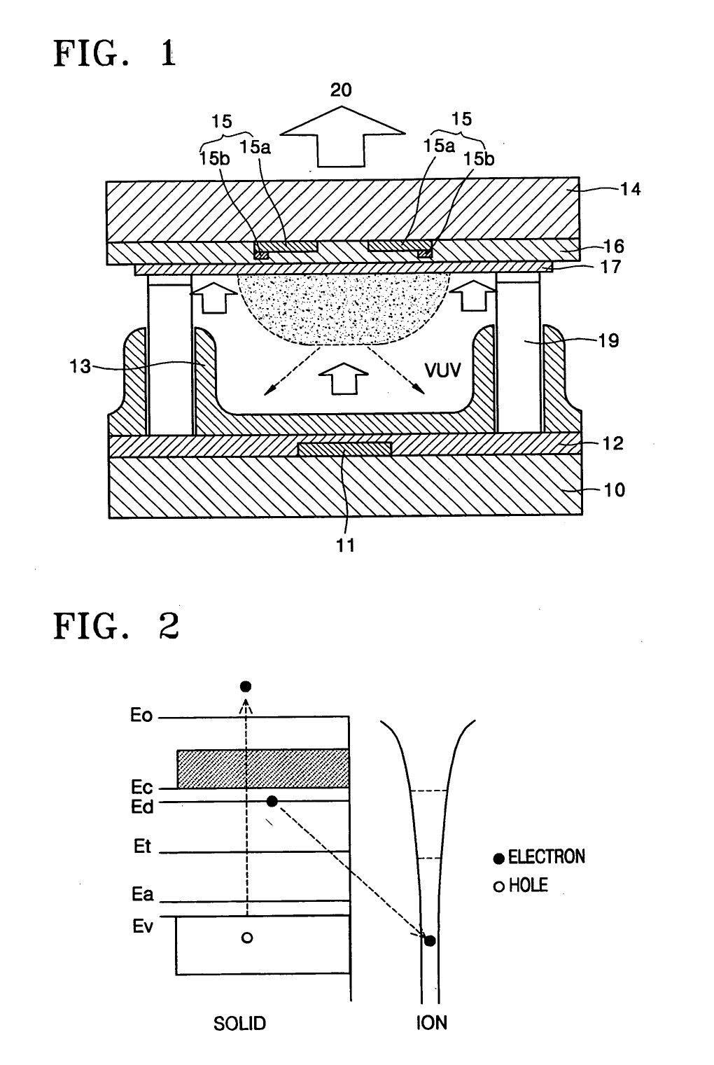

FIG. 1 is a view of an example of a pixel of a Plasma Display Panel (PDP) and illustrates one of hundreds of thousands of PDP pixels. With reference to FIG. 1, a PDP includes a sustain electrode 15 disposed on the lower surface of a front substrate 14, the sustain electrode 15 having a first electrode 15a and a second electrode 15b. The sustain electrodes 15a and 15b are coated with a dielectric layer 16. When the dielectric layer 16 is directly exposed to a discharge environment, discharge characteristics can deteriorate and its lifetime shortened. Accordingly, the dielectric layer 16 is covered with a protecting layer 17.

An address electrode 11 having a predetermined pattern is disposed on a rear substrate 10, and a dielectric layer 12 is formed to cover the address electrode 11 and the rear substrate 10. The front substrate 14 and the rear substrate 10 are disposed opposite to each other. A space between the two substrates is filled with a mixture gas including Ne+Xe or a mixture gas including He+Ne+Xe for generating ultraviolet rays at a predetermined pressure (for example, 450 torr). The Xe gas functions to generate vacuum ultraviolet rays (Xe ion: 147 nm resonance radiation, Xe_{2: 173} nm resonance radiation).

The present invention will now be described more fully hereinafter with reference to the accompanying drawings, in which exemplary embodiments of the present invention are shown. This invention can, however, be embodied in many different forms and should not be construed as being limited to the embodiments set forth herein. Rather, these embodiments are provided so that this disclosure will be thorough and complete, and will fully convey the scope of the present invention to those skilled in the art. Like numbers refer to like elements throughout the specification.

A protecting layer for use in a PDP according to an embodiment of the present invention is composed of a metal and metal oxide. The metal is located away from the surface of the protecting layer by a distance equal to 10% or less of the thickness of the protecting layer. This is explained as follows with reference to FIGS. 4, 5, and 7.

The metal accelerates secondary electron emission of the metal oxide contacting the discharge gas ions, and the metal, itself, can also emit secondary electrons. Hence, a discharge delay time of the protecting layer of the present invention is further reduced, thereby allowing high speed addressing, and thus, realizing a single scan of a High Density (HD) panel. Furthermore, an increase in the number of sustain discharges leads to an increased brightness and an increased sub-field constituting a TV-field, thereby providing an effect such as pseudo contour reduction and the like. The temperature dependency of a discharge delay time is reduced, and thus, a scan circuit margin is increased. Since a discharge initiation voltage is also reduced, an increase in a discharge voltage is reduced even with an increase in a Xe content for high brightness.

Secondary electron emission of the protecting layer according to an embodiment of the present invention can be explained by an Auger neutralization theory as a mechanism in which secondary electrons are emitted from the solid by the collision of gas ions and the solid, and by an additional mechanism in which secondary electrons are emitted from the solid, for example, a metal oxide, by a metal disposed near the solid, and from the metal itself.

First, in the Auger neutralization theory, when gas ion collides with a solid, electrons move from the solid to the gas ion to form a neutral gas, so that holes are generated in the solid. Other electrons from the solid can be emitted by the energy generated as the electrons neutralize the gas ions, and are moved down to a ground state, and the other electrons are called secondary electrons. The relationship can be represented by Formula 1.
Eₖ=E_{I}−2(E_{g}+X) Formula 1

In Formula 1, Eₖ represents an energy generated when electrons are emitted from a solid colliding with gas ions, E_{I} represents an ionization energy of the gas, E_{g} represents a band gap energy of the solid, and X represents an electron affinity of the solid.

The Auger neutralization theory and Formula 1 can be applied to a material forming the protecting layer in the PDP and a discharge gas. If a voltage is supplied to a PDP pixel, seed electrons generated by cosmic rays or ultraviolet rays collide with the discharge gas to generate discharge gas ions. The discharge gas ions collide with the protecting layer, thereby emitting secondary electrons from the material forming the protecting layer by the mechanism as described above.

Table 1, as follows, shows a resonance emitting wavelength of an inert gas used as a discharge gas and ionization voltage, that is, the ionization energy of discharge gas. When a protecting layer is composed of MgO, a band gap energy of MgO as a band gap energy E_{g} of a solid in Formula 1 is 7.7 eV, and the electron affinity X is 0.5. Xe gas is appropriate because it emits vacuum ultraviolet rays having the longest wavelength in order to increase an optical conversion efficiency of a fluorescent material in a PDP. However, because ionization voltage, that is, ionization energy E_{I} of Xe gas is 12.13 eV, when the ionization energy is applied to Formula 1, the energy Eₖ in which electrons are emitted from the protecting layer composed of MgO is less than zero (0), so that discharge voltage is relatively highly increased. Therefore, a gas having a high ionization voltage is necessary in order to lower the discharge voltage. In Formula 1, since Eₖ is 8.19 eV in the case of He, and Eₖ is 5.17 eV in the case of Ne, it is preferable to use He or Ne in order to lower the discharge initiation voltage. However, when He gas is used in a PDP discharge, it causes serious plasma etching of the protecting layer because of the momentum size of He.

TABLE 1
Inert Gas and Ionization Energy

| | | | | metastable level | | |
|---|---|---|---|---|---|---|
| | resonance level excitation | | | excitation | | |
| | voltage | wavelength | life time | voltage | life time | ionization |
| Gas | (V) | (nm) | (ns) | (V) | (ns) | voltage (V) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.28 | 150 | 12.13 |

As noted above, secondary electron discharge can be controlled by controlling components and component ratios of the discharge gases. In addition, the protecting layer, itself, can be composed of a material emitting a large amount of secondary electrons. For this purpose, the protecting layer of the present invention can be composed of a metal and metal oxide.

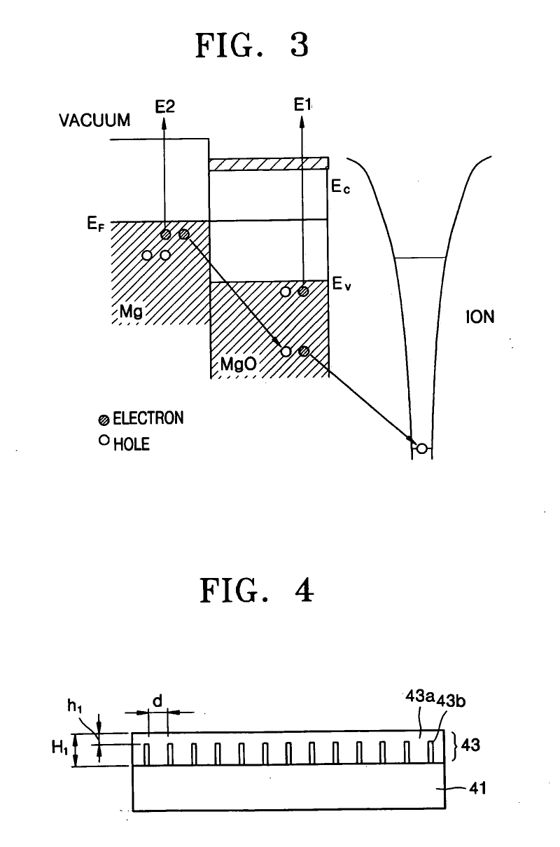

FIG. 3 shows that an emitting amount of secondary electrons is improved when the protecting layer includes a metal in addition to metal oxide.

According to the Auger neutralization theory as described above, after electrons are emitted from a solid, that is, metal oxide, holes are formed in the metal oxide. If the metal oxide is disposed adjacent to the metal, the electrons of the metal can move to the metal oxide so as to neutralize the holes. Hence, Auger neutralization can be accelerated in the metal oxide so as to activate the emission of secondary electrons. Furthermore, additional electrons can be emitted from the metal by the energy generated during the hole neutralization. That is, since the Auger neutralization can be accelerated in the metal oxide by using the metal, and secondary electrons are emitted from the metal, itself, a larger amount of secondary electrons can be emitted as compared to the protecting layer composed of only the metal oxide without the metal.

The metal can be disposed away from the surface of the protecting layer by 10% or less of the thickness of the protecting layer, preferably 5% or less, and more preferably 1% or less. The metal can also be disposed on the surface of the protecting layer (the metal existing on the surface of the protecting layer being the same as “the metal being disposed away from the surface of the protecting layer by 0% of the thickness of the protecting layer”). This is intended to maximize a phenomenon that electron emission is increased by the additional reaction of the metal as schematically shown in FIG. 3, and to suppress a phenomenon that emitted electrons are reabsorbed into the protecting layer.

Therefore, when the protecting layer of the present invention is formed with a thickness of 700Å, the metal inside the protecting layer is disposed away from the surface of the protecting layer by 70Å or less, preferably 35Å or less, and more preferably 7Å or less. The metal is also disposed on the surface of the protecting layer. The locations of the metal in the protecting layer are explained in more detail below with reference to FIGS. 4 through 7.

The metal of the protecting layer according to an embodiment of the present invention can be a metal being capable of facilitating Auger neutralization of the metal oxide of the protecting layer and emitting secondary electrons by itself. The metal can include one or more metals selected from the group consisting of, for example, Mg, Al, Sc, Ti, Cr, Ni, Cu and Mo, but is not limited to this group. Among these metals, Mg is preferable.

The metal oxide of the protecting layer according to an embodiment of the present invention can be a material capable of causing Auger neutralization when it contacts a discharge gas, and having a resistance property to sputtering of the discharge gas, a good durability, and the like. The metal oxide can be, for example, magnesium oxide. The magnesium oxide of the protecting layer is a wide band-gap material like diamonds, and can have an electron affinity having a very small dimension or being negative.

In the protecting layer according to an embodiment of the present invention, the metal and the metal oxide can be prepared in various configurations. Hereinafter, various embodiments of the protecting layer according to embodiments of the present invention are described below with reference to FIGS. 4 through 7.

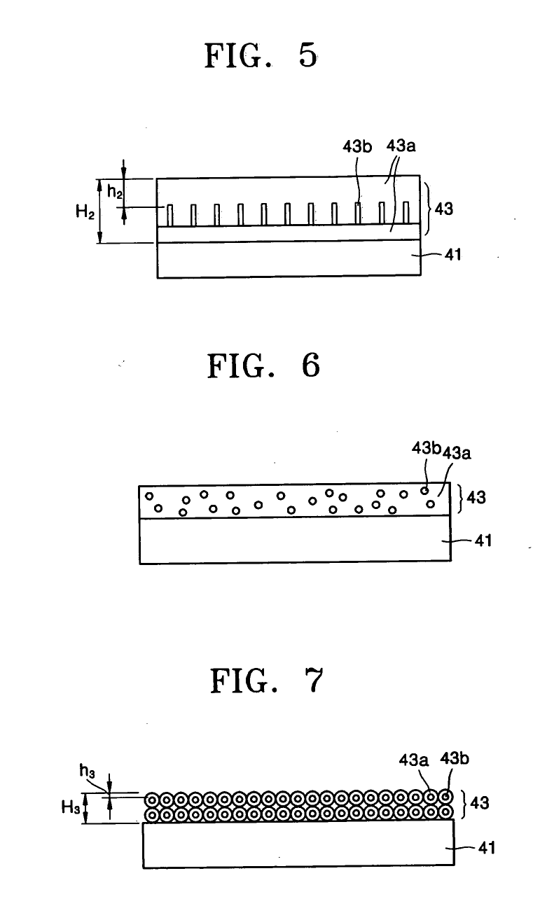

In one exemplary embodiment of the protecting layer according to the present invention, the metal included in the protecting layer can have a predetermined pattern. The protecting layer refers to FIGS. 4 and 5.

In FIG. 4, a protecting layer 43 is composed of a metal 43b having a predetermined pattern, and a metal oxide layer 43a covering the metal 43b. The protecting layer 43 is disposed on a substrate 41.

The metal 43b of the protecting layer 43 is disposed away from the surface of the protecting layer 43 by 10% or less of the thickness of the protecting layer. That is, as shown in FIG. 4, a thickness h1 of the protecting layer region, in which the metal does not exist in the protecting layer, is 10% or less than the thickness H₁ of the protecting layer. For example, when H₁ is 700Å, h₁ is 70Å or less. This is because secondary electron emission can be accelerated as the metal is disposed closer to the surface of the protecting layer.

The substrate 41 is a support body including a region in which the protecting layer is formed, as is well understood to those skilled in this art. The substrate can mean, for example, the upper surface of a dielectric layer among a front panel of a PDP including a substrate composed of glass, etc., sustain electrode pairs of Y electrode and X electrode, and a dielectric layer covering the sustain electrode pairs. Hereinafter, the substrate 41 used in this specification can be understood as being described above.

The metal 43b is formed as a predetermined pattern on the substrate 41. The metal 43b is not restricted to a specific pattern, but must satisfy Auger neutralization activation and secondary electron emission of the metal oxide 43a to the maximum when the metal 43b contacts the metal oxide 43a at its closest, while not interfering with an insulation property of the protecting layer 43.

In consideration of this, a distance d between patterns of the metal 43b can be 100 nm through 50 μm, and preferably, 500 nm through 1000 nm. When the distance d between patterns is less than 100 nm, the protecting layer 43 can be conductive, and when the distance d between patterns exceeds 50 μm, since a total contact area of the metal oxide and the metal can be reduced, the Auger neutralization activation and the secondary electron emission can not be made effectively.

A shape of the metal 43b is not restricted to a specific pattern. For example, the pattern of the metal 43b can have a dot shape or short stripe shape, and can be modified into various shapes.

In FIG. 5, the metal 43b having a predetermined pattern is completely buried by the metal oxide layer 43a. This is fabricated by forming the metal oxide layer 43a between the metal 43b and the substrate 41.

The metal 43b of the protecting layer 43 is disposed away from the surface of the protecting layer by 10% or less of the thickness of the protecting layer. That is, as shown in FIG. 5, a thickness h₂ of the protecting layer region, in which the metal does not exist in the protecting layer, is 10% or less than the thickness H₂ of the protecting layer. For example, if H₂ is 700Å, then h₂ is 70Å or less. This is because secondary electron emission can be accelerated as the metal is disposed closer to the surface of the protecting layer.

In FIG. 6, the metal 43b has a particle shape, and the particles of the metal 43b are dispersed inside the metal oxide layer 43a. In the protecting layer of FIG. 6, it is important to uniformly disperse the metal 43b inside the metal oxide layer 43a. However, if the metal 43b is not uniformly dispersed, but is formed as clusters, an insulation property of the protecting layer can be damaged, and a discharge dispersion problem can occur. The metal 43b can be uniformly dispersed inside the protecting layer 43, and can be disposed away from the surface of the protecting layer 43 by 10% or less than the thickness of the protecting layer.

In FIG. 7, the metal 43b has a particle shape, and each particle is coated with the metal oxide 43a.

The metal 43b of the protecting layer 43 is disposed away from the surface of the protecting layer 43 by 10% or less than the thickness of the protecting layer. That is, as shown in FIG. 7, a thickness h₃ of the protecting layer region, in which the metal does not exist in the protecting layer, is 10% or less than the thickness H₃ of the protecting layer. For example, if H₃ is 700Å, then h₃ is 70Å or less. This is because secondary electron emission can be accelerated as the metal is disposed closer to the surface of the protecting layer.

As above, since the metal 43b is dispersed in the metal oxide 43a, or the surface of the metal 43b is coated with the metal oxide 43a, the decreased insulation problem can be prevented by using a metal in the protecting layer, and the Auger neutralization and the secondary emission of the metal oxide can be effectively achieved by maximizing a contact area between the metal and the metal oxide.

A diameter of the metal 43b can be, for example, 50 nm through 1 μm, and preferably, 50 nm through 500 nm. When the diameter of the metal 43b is less than 50 nm, fabrication costs are increased, and when the diameter of the metal 43b exceeds 1 μm, the protecting layer for use in a PDP cannot be formed with an appropriate thickness.

As shown in FIG. 7, when the metal 43b is coated with the metal oxide 43a, h₃ is controlled to be 10% or less of H₃, and preferably, a coating thickness of the metal oxide 43a can be 100 nm through 2 μm, and more preferably, 100 nm through 1 μm. When a coating thickness of the metal oxide 43a is less than 100 nm, a content of the metal 43b is relatively increased so that the protecting layer can be conductive, and when a coating thickness of the metal oxide 43a exceeds 2 μm, a total contact area between the metal 43b and the metal oxide 43a is decreased. As a result, the Auger neutralization effect using a metal cannot be sufficiently expected.

The protecting layer according to embodiments of the present invention has been described in reference to FIGS. 4 through 7, but the description was intended to explain the protecting layer of the present invention, which is not limited to the description, and it is apparent to employ various modifications.

The protecting layer of the present invention can be formed using various methods. An exemplary embodiment of the methods of forming the protecting layer according to the present invention includes preparing a substrate; forming a predetermined pattern composed of a metal on the substrate; and forming a magnesium oxide layer to cover the metal having the predetermined pattern, thereby forming a protecting layer. The operation of forming the magnesium oxide layer can be performed such that the metal having the predetermined pattern is disposed away from the surface of the protecting layer 10% or less than the thickness of the protecting layer. According to the method of forming a protecting layer as described above, the protecting layer can be achieved as illustrated in, for example, FIGS. 4 and 5.

The substrate is a support body including a protecting layer formation region as described above. For example, when the substrate is a front dielectric layer in a front panel of a PDP, the substrate can be composed of PbO, etc.

Then, a predetermined pattern composed of a metal is formed on the substrate. The metal can include one or more metals selected from the group consisting of Mg, Al, Sc, Ti, Cr, Ni, Cu and Mo. The method of forming the metal pattern is not restricted to a specific method, but a standard photolithography method can be used, for example. The protecting layer is formed so as not to be conductive by controlling a distance between patterns as described above.

A method of forming a metal oxide layer to cover the predetermined pattern composed of the metal can use various conventional methods. More specifically, the method can include an electron beam evaporation method, a sputtering method, and the like, but the method is not limited thereto.

In the method of forming the protecting layer, after the substrate is prepared, a metal oxide layer can be formed on the substrate. The metal with a predetermined pattern described above is formed on the metal oxide layer formed as above, and a metal oxide layer can be formed again to cover the above. Thus, a protecting layer is achieved, in which a metal with a predetermined pattern is completely buried by metal oxide.

Another embodiment of the method of forming the protecting layer according to the present invention can include preparing evaporation sources for a metal and metal oxide, and a substrate; and forming layers composed of the metal and the metal oxide on the substrate, using the evaporation sources.

The evaporation source can be prepared in various ways to supply a metal including one or more metals selected from the group consisting of Mg, Al, Sc, Ti, Cr, Ni, Cu and Mo, and magnesium oxide.

The evaporation source can be, for example, pellets composed of magnesium (Mg). Using the magnesium pellet evaporation source, layers composed of magnesium and magnesium oxide are formed by controlling an oxygen flow during the layer formation.

An evaporation source composed of two or more different materials can be prepared. For example, an evaporation source composed of the metal and magnesium oxide can be prepared. The metal can use an evaporation source surface-coated with magnesium oxide. The magnesium coating can be formed using various methods, such as a screen printing method.

The evaporation source composed of two or more different materials can be a single evaporation source including all of these, or two or more evaporation sources, in which materials are individually prepared. In the formation of the single evaporation source, the materials can be uniformly mixed by employing a dry mixing method or a wet mixing method using flux, etc.

The method of forming the layer using the evaporation source prepared as above can employ various conventional methods. For example, the method can include an electron beam evaporation method, a sputtering method, an ion-plating method, and the like, but the method is not limited thereto.

The method of forming the protecting layer according to the present invention has been described with exemplary embodiments as described above, but the method is not limited to these, and various modifications are possible.

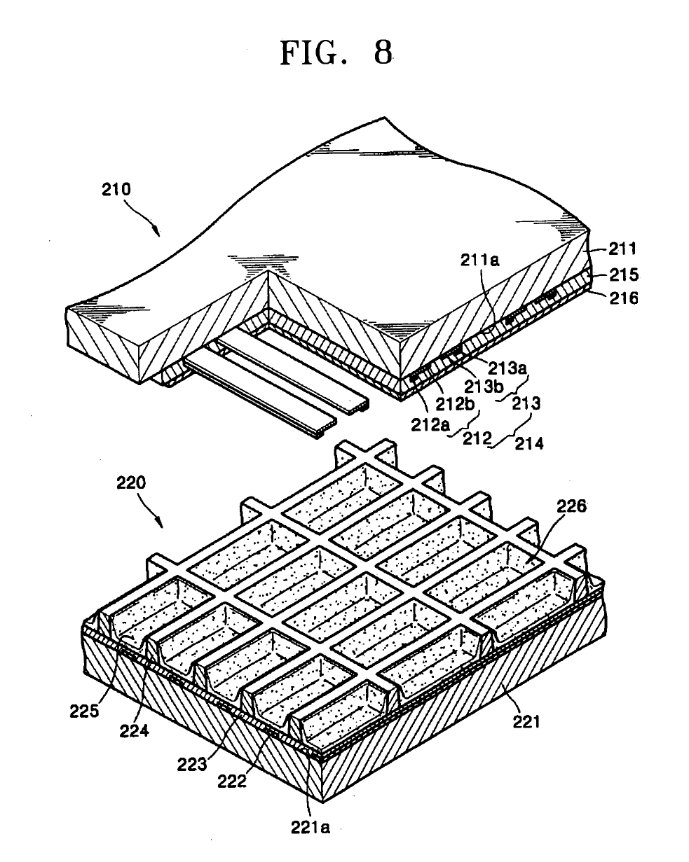

The protecting layer as described above, and the protecting layer formed by the method of forming a protecting layer as described above can be employed in a PDP. FIG. 8 illustrates an example of the PDP having the protecting layer according to the present invention.

In FIG. 8, a front panel 210 includes a front substrate 211, pairs of sustain electrodes 214, each pair of electrodes having a Y-electrode 212 and an X-electrode 213, which are formed on a rear surface 211a of the front substrate, a front dielectric layer 215 covering the pairs of the sustain electrodes, and a protecting layer 216 composed of a metal and metal oxide according to the present invention. Since the protecting layer 216 employs a metal capable of accelerating Auger neutralization of the metal oxide and emitting secondary electrons by itself, the protecting layer 216 can have excellent secondary electrons emission characteristics, discharge characteristics, and the like. Related to this, a detailed description is the same as described above, and thus, a description thereof has been omitted herein. The Y-electrode 212 and the X-electrode 213 are respectively composed of transparent electrodes 212b and 213b formed of ITO, etc., and bus electrodes 212a and 213a formed of a metal having a good conductivity.

The rear panel 220 includes a rear substrate 221, address electrodes 222 formed on a front surface 221a of the rear substrate to cross the sustain electrodes pairs, a rear dielectric layer 223 covering the address electrodes, a barrier rib 224 formed on the rear dielectric layer to separate illuminant cells 226, and a fluorescent layer 225 disposed inside each of the illuminant cells. A discharge gas inside the illuminant cells can be a mixture gas formed by mixing one or more gases selected from Xe, He, and Kr with Ne.

Hereinafter, the present invention is explained in more detail through embodiments.

### Embodiment 1

A bus electrode composed of copper is formed on a glass substrate with a thickness of 2 mm, using a photolithography process. The bus electrode is coated with PbO glass, and a front dielectric layer is formed with a thickness of 20 μm. Then, an evaporation source composed of MgO pellets is used to deposit an MgO layer on the dielectric layer, using an electron beam evaporation method to form a MgO layer with a thickness of 500 nm on the dielectric layer. A temperature of the substrate is 250° C. during evaporation, and an evaporation pressure is controlled to 1.5×10-4 torr by supplying oxygen gas and argon gas via a gas flow controller. Mg patterns are formed on the MgO layer using a standard photolithography method, and a distance between the patterns is 2 μm, a pattern width is 50 nm, and a pattern height is 193 nm. Then, a MgO layer is formed to cover the Mg patterns. Thus, a protecting layer (refer to FIG. 5) is formed to have a total thickness of 700 nm, in which the Mg patterns are completely buried by the MgO layer, thereby forming a front substrate. Describing the protecting layer formed by the method in more detail with reference to FIG. 5, H₂ is 700 nm, h₂ is 7 nm, and the Mg patterns are disposed away from the surface of the protecting layer by 1% of the thickness of the protecting layer.

An address electrode composed of copper is formed on a glass substrate with a thickness of 2 mm, using a photolithography method. The address electrode is coated with PbO glass, thereby forming a rear dielectric layer with a thickness of 20 μm. Then, Zn₂SiO₄; Mn green illuminant fluorescent body (produced by Kasei Co., for example) is formed on the rear dielectric layer, thereby forming a rear substrate.

By making the front substrate and the rear substrate face opposite to each other with a distance of 130 μm, a cell is formed, and by a discharge gas supplying into the cell including mixture gases of 95% of neon and 5% of xenon, a PDP is fabricated, which is called a panel 1.

### Embodiment 2

A PDP is fabricated using the same method as embodiment 1, except for using Al metal instead of Mg metal during the formation of the front substrate. This is called a panel 2.

### COMPARATIVE EXAMPLE 1

A PDP is fabricated using the same method as the embodiment 1, except for forming a protecting layer composed of only MgO with a thickness of 700 nm during the formation of the front substrate. This is called a panel A. The panels 1 and 2 according to the present invention have good discharge initiation voltage and discharge delay-time properties compared with the panel A.

The protecting layer for use in a PDP according to the present invention is composed of a metal and metal oxide, and since the metal is disposed away from the surface of the protecting layer by 10% or less than the thickness of the protecting layer, excellent protecting characteristic of dielectrics, secondary electrons emission characteristic, and discharge characteristic are provided. Therefore, the protecting layer is also advantageous to increase the Xe gas content and single scan. Furthermore, by using the protecting layer, a PDP is provided with high brightness, and an improved reliability with a long life time.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A protecting layer of a Plasma Display Panel (PDP), the protecting layer comprising:
a metal;
and metal oxide;
wherein the metal is disposed away from a surface of the protecting layer by 10% or less than a thickness of the protecting layer.

2. The protecting layer according to claim 1, wherein the metal is disposed away from a surface of the protecting layer by 5% or less than the thickness of the protecting layer.

3. The protecting layer according to claim 1, wherein the metal comprises one or more metals selected from the group consisting of Mg, Al, Sc, Ti, Cr, Ni, Cu, and Mo.

4. The protecting layer according to claim 1, wherein the metal oxide comprises magnesium oxide.

5. The protecting layer according to claim 1, wherein the metal comprises a predetermined pattern.

6. The protecting layer according to claim 5, wherein a distance between patterns is in a range of 100 nm to 50 μm.

7. The protecting layer according to claim 5, wherein the metal having a predetermined pattern is buried into a layer composed of the metal oxide.

8. The protecting layer according to claim 1, wherein the metal has a particle shape, and is dispersed into a layer composed of the metal oxide.

9. The protecting layer according to claim 1, wherein the metal has a particle shape, and is surface-coated with the metal oxide.

10. The protecting layer according to claim 8, wherein the metal having a particle shape has a diameter in a range of 50 nm to 1 μm.

11. The protecting layer according to claim 9, wherein the metal having a particle shape has a diameter in a range of 50 nm to 1 μm.

12. A method of forming a protecting layer of a Plasma Display Panel (PDP), the method comprising:
preparing a substrate;
forming a predetermined pattern composed of a metal on the substrate; and
forming a layer composed of magnesium oxide to cover the metal having the predetermined pattern;
wherein forming a layer composed of magnesium oxide arranges the metal having the predetermined pattern to be disposed away from a surface of the protecting layer by 10% or less than the thickness of the protecting layer.

13. The method according to claim 12, further comprising forming a layer composed of magnesium oxide on the substrate before forming a predetermined pattern composed of the metal.

14. A method of forming a protecting layer of a PDP, the method comprising:
preparing an evaporation source supplying metal and magnesium oxide, and a substrate; and
forming a layer composed of the metal and magnesium oxide on the substrate, using the evaporation source.

15. A Plasma Display Panel (PDP), comprising:
a protecting layer, the protecting layer including:
a metal;
and metal oxide;
wherein the metal is disposed away from a surface of the protecting layer by 10% or less than a thickness of the protecting layer.

16. The PDP according to claim 15, wherein the metal is disposed away from a surface of the protecting layer by 5% or less than the thickness of the protecting layer.

17. The PDP according to claim 15, wherein the metal comprises one or more metals selected from the group consisting of Mg, Al, Sc, Ti, Cr, Ni, Cu, and Mo.

18. The PDP according to claim 15, wherein the metal oxide comprises magnesium oxide.

19. The PDP according to claim 15, wherein the metal comprises a predetermined pattern.

20. The PDP according to claim 19, wherein a distance between patterns is in a range of 100 nm to 50 μm.

21. The PDP according to claim 19, wherein the metal having a predetermined pattern is buried into a layer composed of the metal oxide.

22. The PDP according to claim 15, wherein the metal has a particle shape, and is dispersed into a layer composed of the metal oxide.

23. The PDP according to claim 15, wherein the metal has a particle shape, and is surface-coated with the metal oxide.

24. The PDP according to claim 22, wherein the metal having a particle shape has a diameter in a range of 50 nm to 1 μm.

25. The PDP according to claim 23, wherein the metal having a particle shape has a diameter in a range of 50 nm to 1 μm.

26. A method of forming a Plasma Display Panel (PDP), the method comprising:
forming a protecting layer including:
preparing a substrate;
forming a predetermined pattern composed of a metal on the substrate; and
forming a layer composed of magnesium oxide to cover the metal having the predetermined pattern;
wherein forming a layer composed of magnesium oxide arranges the metal having the predetermined pattern to be disposed away from a surface of the protecting layer by 10% or less than the thickness of the protecting layer.

27. The method according to claim 26, further comprising forming a layer composed of magnesium oxide on the substrate before forming a predetermined pattern composed of the metal.

28. A method of forming a Plasma Display Panel (PDP), the method comprising:
forming a protecting layer including:
preparing an evaporation source supplying metal and magnesium oxide, and a substrate; and
forming a layer composed of the metal and magnesium oxide on the substrate, using the evaporation source.
